(19) United States
(12) Patent Application Publication
(10) Pub. No.: US 2008/0274929 A1
(43) Pub. Date: Nov. 6, 2008

(54) METHOD FOR REMOVING MICROBES FROM SURFACES

(76) Inventors: Wilson K. Whitekettle, Jamison, PA (US); Juan Jiang, Shanghai (CN); Linna Wang, Shanghai (CN)

Correspondence Address: General Electric Company;Global Patent Operation, 187 Danbury Road, Suite 204, Wilton, CT, 06897-4122, US

(21) Appl. No.: 11/742,817

(22) Filed: May 1, 2007

(51) Int. Cl. C11D 3/43

(52) U.S. Cl. 510/199

(57) ABSTRACT

A method has been found for the removal of microbial biofilm on surfaces in contact with systems, including but not limited to aqueous systems, which comprises adding to the aqueous system an effective amount of a polyethyleneimine surfactant to substantially remove microbial biofilm, from surfaces in aquatic systems, while presenting minimal danger to non-target aquatic organisms at discharge due to their very low discharge concentrations.

### FIELD OF THE INVENTION

The field of the invention relates to methods for removing microbial biofilm from surfaces in contact with systems, including but not limited to aqueous systems. More particularly, the invention relates to the use of biodispersants for removal of microbial biofilm.

### BACKGROUND OF THE INVENTION

It is well known that bacteria attach to surfaces in any non-sterile aquatic environment. Industrial efforts to prevent colonization or to clean fouled surfaces amount to costly expenditures in many industries. Often such expenditures are made for cleaning programs that include the use of surfactants. Surfactants are regularly applied in water treatment programs as agents believed to play a role in the removal of organic masses from surfaces, in the enhancement of biocide efficacy or in the assistance in the water miscibility of various biocidal agents. Surfactants are also generally used in the agrichemical businesses, particularly to increase the effectiveness of herbicides. This is accomplished by using the surfactants to alter the surface area of the applied droplets, maximizing their interaction with leaf surfaces.

There are numerous examples of surfactants that inhibit the colonization of surfaces by inhibiting the overall growth of organisms in the growth target environment. Most surfactants, regardless of class, inhibit surface colonization when used in concentrations high enough to impede bacterial growth. In the water treatment industry, the most well known surfactants, which impart a measure of colonization resistance to submerged surfaces, include the cationic quaternary amine surfactants, which also function as biocides. Other surfactants, including anionic or non-ionic in chemical character, act to change the surface energy and prevent the microbes from attaching or growing at the water/surface interface. However, even the relatively mild nonionic or anionic surfactants can exhibit toxic effects upon microbes, such as bacteria, algae or fungi. The concentration of nonionic surfactants necessary to mediate toxicity is typically substantially higher than for cationic surfactants. Additionally, the more non-toxic surfactants often require higher levels of concentrations to achieve their purpose, thereby making them uneconomical, prone to forming high level of unwanted foam, and toxic to non-target aquatic organisms upon discharge to common receiving bodies of water.

Examples of nontoxic control of surface colonization typically require the use of high concentration of surfactants not possible in water treatment industries where thousands or millions of gallons of water would be treated. Accordingly, a need exists for a surfactant that can be used in water treatment industries, exhibiting lower levels of toxicity, and effectiveness at lower dosages so there is an economical advantage.

### SUMMARY OF THE INVENTION

A method has been found for the removal of microbial biofilm on surfaces in contact with systems, such as but not limited to, aqueous systems, which comprises adding to the system an effective amount of a polyethyleneimine surfactant to substantially remove microbial biofilm, from surfaces in systems, while presenting minimal danger to non-target aquatic organisms at discharge due to their very low discharge concentrations. Additionally, due to the low dosage required, there are economical advantages as well.

The various features of novelty that characterize the invention are pointed out with particularity in the claims annexed to and forming a part of this disclosure. Changes to and substitutions of the various components of the invention can of course be made. The invention resides as well in sub-combinations and sub-systems of the elements described, and in methods of using them.

### DESCRIPTION OF THE INVENTION

Approximating language, as used herein throughout the specification and claims, may be applied to modify any quantitative representation that could permissibly vary without resulting in a change in the basic function to which it is related. Accordingly, a value modified by a term or terms, such as “about”, are not limited to the precise value specified. In at least some instances, the approximating language may correspond to the precision of an instrument for measuring the value. Range limitations may be combined and/or interchanged, and such ranges are identified and include all the sub-ranges included herein unless context or language indicates otherwise. Other than in the operating examples or where otherwise indicated, all numbers or expressions referring to quantities of ingredients, reaction conditions and the like, used in the specification and the claims, are to be understood as modified in all instances by the term “about”.

As used herein, the terms “comprises,” “comprising,” “includes,” “including,” “has,” “having” or any other variation thereof, are intended to cover a non-exclusive inclusion. For example, a process, method, article or apparatus that comprises a list of elements is not necessarily limited to only those elements, but may include other elements not expressly listed or inherent to such process, method article or apparatus.

In one embodiment of the present invention, the dispersant removes or reduces microbial slime from surfaces in contact with aqueous systems better than that caused by water alone. Microbial slime includes, but is not limited to, metabolizing cells plus exopolysaccharides. The dispersant performs this function without killing the microorganisms responsible for the adhesion. Therefore, this methodology has beneficial environmental effects, as it presents minimal danger to non-target aquatic organisms present in waste treatment systems or in other recipients of the discharge due to its very low discharge concentrations. Additionally, the dispersant according to an embodiment of the present invention does not cause excess amounts of foam that would be unacceptable in many aquatic systems.

An embodiment of the present invention provides a method for removing microbial biofilm on surfaces in contact with systems, including but not limited to aqueous systems, comprising adding to the system an effective amount of a dispersant comprised of polyethyleneimine surfactants. Polyethyleneimine is a polymeric amine with a high charge density that allows for it to absorb tightly to negatively charged substrates. It is a water soluble polymer made by the polymerization of ethyleneimine. It is not an entirely linear structure but a partly branched polymer containing primary, secondary and tertiary amines. The molecular formula for polyethyleneimine is C₆H₂₁N₁₅, and can be evidenced by the following structure:

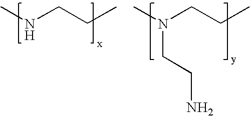

Polyethyleneimine is a low molecular weight ethyleneimine copolymer. The molecular weight of the polyethyleneimine is from about 1000 to about 3000, with an alternate range of from about 500 to about 750,000. Examples of the polyethyleneimine surfactants include, but are not limited to, the BASF Lupasols G20/G35™ (BASF Corporation, Florham Park, N.J.).

The dispersant comprises from about 20 to about 98 percent by weight of polyethyleneimine, with the remainder of the dispersant comprising water, which can be present in an amount of from about 2 to about 80% by weight. Additional components may included solvents, such as low molecular weight alcohols, for example, ethanol, methanol and butanol. One embodiment of polyethyleneimine is comprised of from about 40 to about 50% water and about 40 to about 50% 1,2-ethanediamine, polymer with aziridine.

The polyethyleneimine surfactants have an added advantage of being able to perform over extended periods of time in aqueous media as compared to other surfactants. One reason for this is that they are more adsorptive onto surfaces than other surfactants, such as for example, ethylene oxide and/or propylene oxide (EO/PO) copolymers. Polyethyleneimine differs from other dispersants and surfactants used for similar purposes, in that polyethyleneimine contains nitrogen in its backbone, dispersed throughout the carbons. Other known dispersants have backbones consisting solely of carbon atoms. The presence of the nitrogen in the backbone of polyethyleneimine contributes to its ability to be more adsorptive on surfaces than prior known surfactants.

Polyetheneimine surfactants maintain performance over a broad range of pH systems, and are therefore advantageous for use in various aqueous systems. The polyethenieimine surfactants can be used in aqueous systems that have a pH of from about 3.5 to about 10.5.

The dispersant according to the present invention is preferably included in the aqueous system at a concentration of at least from about 2 parts per million (ppm) to about 400 ppm, with an alternative range of from about 20 to about 120 ppm, and a further embodiment of about 40 to about 60 ppm. As one embodiment of the dispersant, Lupasol G35™ (BASF Florham Park, N.J.) is about 50% active, the concentrations given above are for the product concentrations, as opposed to the active concentrations. To obtain active concentrations of the dispersant, in this example, divide by two, so that if there is 100 ppm of Lupasol G35,™ then the active concentration is 50 ppm.

The dispersant according to the present invention can be utilized in a variety of aqueous systems, such as, but not limited to, open recirculating cooling water systems, pulping and papermaking systems, water transport pipelines, closed cooling systems, reverse osmosis systems, air washer systems, shower water systems, once-through water systems, hydrocarbon storage systems, hydrocarbon transport pipelines, metalworking fluid systems, and aqueous mineral processing systems.

The invention will now be described with respect to certain examples that are merely representative of the invention and should not be construed as limiting thereof.

### EXAMPLES

The invention is illustrated in the following non-limiting examples, which are provided for the purpose of representation, and are not to be construed as limiting the scope of the invention. All parts and percentages in the examples are by weight unless indicated otherwise.

In order to demonstrate efficacy of the present invention, a method was developed which allowed for the screening of dispersant ability to remove a bacterial biofilm. This method involved the colonization of commercially available 316 stainless steel coupons by bacteria, and their removal in the presence/absence of dispersants. The number of bacteria on a set of coupons was then determined by standard methods.

The bacterial species Pseudomonas fluorescens was chosen for these studies as this species is one that is common on submerged surfaces, and therefore would be one that could be expected to be found in process water streams.

The biofilm attached to the 316 stainless steel was formed by starting a 5 ml culture of Pseudomonas fluorescens in Nutrient Broth, it was incubated and shaken, overnight at 30° C. The next day, 1 ml of the culture was transferred into a 1.5 ml eppendorf tube. The culture was then placed in a centrifuge for 10 minutes at 10,000 g at 4° C. The liquid was decanted and the cell pellet resuspended in 0.85% sterile saline.

The transfer and centrifuge of the culture was repeated. Thereafter, Pseudomonas fluorescens cell pellet was resuspended in 1 ml of 0.85% sterile saline buffer and diluted with sterile saline buffer to OD₆₀₀˜0.050±0.02. A #4 Whatman filter paper was placed on top of all the Nutrient Broth plates needed, and 2 ml of prepared cell suspension was placed on top of each filter. Three 316 stainless steel coupons were placed on the filter paper of each Petri dish, and they were incubated at 30° C. for 24 hours. Biofilm was allowed to form on one side of the two sided coupons.

In order to show biodispersant treatment for biofilm coated coupons, on the third day, simulation cooling tower water was prepared and filtered to sterilization. A biodispersant stock solution (10,000 ppm) was prepared. Each beaker was filled with 700 ml cooling water and then an amount of cooling water was removed from each beaker equal to the amount of biocide/or dispersant that will be added to each particular beaker.

Appropriate amounts of biodispersant were added to each beaker at the concentration levels to be tested. The solutions were thoroughly mixed using the multi-stirrer. One beaker was maintained as a control and contained only 700 ml of simulation cooling water. Thereafter, three coupons with biofilm were aseptically placed on coupon holders, and then each coupon holder was placed into a slot in the coupon holder lid. Beakers were placed on a multi-stirrer and the stirring action was adjusted to mix the solution in the beaker gently for 24 hours.

35 ml sterile saline buffer were placed into 50 ml centrifuge tubes and one biofilm coupon was aseptically transferred into each centrifuge tube. Sonication was properly conduct in each tube to remove any remaining Pseudomonas fluorescens biofilm bacteria from each coupon and dispersed in a saline buffer.

Serial dilutions were performed using sterile saline buffer. Biofilm cell dilutions were inoculated on Petrifilm (3M Company). The Petrifilms are incubated at 30° C. for 48 hours, and the CFU (colony forming units) were read. Colony forming units (cfu)/cm² (Biofilm density) is determined by factoring the appropriate dilution and dividing the cell count obtained by 8.77 cm² (area of one side of a standard 316SS (stainless steel) corrosion coupon). The % of the biofilm removed was calculated by subtracting the above % calculation for each treatment from 100%. (biofilm controls minus treated).

(Optional calculation: % Reduction Achieved By Biodispersant=(Control Count-Treated Count)×100/Control Count)×100

The results of the polyetheleneimine on biofilm removal is shown in the tables and graphs below. Results are shown for two different products, Lupasol G 35, and Lupasol G20, both produced by BASF, Florham Park, N.J.

TABLE I
Results of Polyethyleneimine on Biofilm Removal(Beaker Test)

| Beaker-Test: 50 ppm 20% G35 | | | | | | |
|---|---|---|---|---|---|---|
| and 50 ppm EO/PO copolymers | | | | cfu/cm2 | | SD/cfu/cm2 |
| Biofilm Removal Efficacy Test | | | cfu/cm2/ml | (average) | SD | (average) |
| | Coupon1 | 780,000 | 3,112,885 | 3,778,031 | 802,487 | 21.2% |
| Control-1 | Coupon2 | 890,000 | 3,551,881 | | | |
| | Coupon3 | 1,170,000 | 4,669,327 | | | |
| | Coupon1 | 1,270,000 | 5,068,415 | 3,139,491 | 1,877,976 | 59.8% |
| Control-2 | Coupon2 | 760,000 | 3,033,067 | | | |
| | Coupon3 | 330,000 | 1,316,990 | | | |
| | Coupon1 | 1,210,000 | 4,828,962 | 4,682,630 | 399,752 | 8.5% |
| 50 ppm EO/PO copolymers | Coupon2 | 1,060,000 | 4,230,331 | | | |
| | Coupon3 | 1,250,000 | 4,988,597 | | | |
| | Coupon1 | 1,060,000 | 4,230,331 | 2,833,523 | 1,246,151 | 44.0% |
| 50 ppm 20% Lupasol G35 | Coupon2 | 610,000 | 2,434,436 | | | |
| | Coupon3 | 460,000 | 1,835,804 | | | |

TABLE II

| | cfu/cm2 | | SD/cfu/cm2 | |
|---|---|---|---|---|
| | (average) | SD | (average) | Biofilm Removal |
| control | 3,458,761 | 1,338,145 | 38.7% | |
| 50 ppm EO/PO | 4,682,630 | 399,752 | 8.5% | −35.4% |
| copolymer | | | | |
| 50 ppm 20% | 2,833,523 | 1,246,151 | 44.0% | 18.1% |
| Lupasol G35 | | | | |

TABLE III
Results of Polyethyleneimine on Biofilm Removal(Beaker Test)

| Beaker-Test: 50 ppm 20% Lupasol G35 | | | | | | |
|---|---|---|---|---|---|---|
| and 50 ppm EO/PO copolymer Biofilm | | cfu/ | | cfu/cm2 | | SD/cfu/cm2 |
| Removal Efficacy Test | | Petrifilm | cfu/cm2 | (average) | SD | (average) |
| Control | Coupon1 | 224,000 | 893957 | 1,165,336 | 383,789 | 32.9% |
| | Coupon2 | 360,000 | 1436716 | | | |
| | Coupon3 | | | | | |
| 50 ppm EO/PO copolymer | Coupon1 | 299,000 | 1193273 | 1,169,327 | 33,864 | 2.9% |
| | Coupon2 | 287,000 | 1145382 | | | |
| | Coupon3 | | | | | |
| 50 ppm 20% Lupasol G35 | Coupon1 | 75,000 | 299316 | 393,767 | 82,016 | 20.8% |
| | Coupon2 | 112,000 | 446978 | | | |
| | Coupon3 | 109,000 | 435006 | | | |
| 50 ppm 20% Lupasol G35 | Coupon1 | 104,000 | 415051 | 484,227 | 69,850 | 27.0% |
| | Coupon2 | 121,000 | 482896 | | | |
| | Coupon3 | 139,000 | 554732 | | | |

TABLE IV

| | cfu/cm2 | | SD/cfu/cm² | Biofilm |
|---|---|---|---|---|
| | (average) | SD | (average) | Removal |
| Control | 1,165,336 | 383,789 | 32.9% | |
| 50 ppm EO/PO | 1,169,327 | 33,864 | 2.9% | |
| copolymer | | | | |
| 50 ppm 20% G35 | 393,767 | 82,016 | 20.8% | 66.2% |
| 50 ppm 20% G35 | 484,227 | 69,850 | 27.0% | 58.5% |

In further experiments, microplate testing was performed comparing the claimed reagent, against alternate reagent and no reagent. In that test, a culture of Pseudomonas fluorescens (PF) ATCC 13525 was diluted with sterile TSB (tryptic soy broth) to final OD 600 nm=0.05. 200 μl PF dilution was inoculated into each well on a clear plastic microplate (Costar #3599), except for the blank wells, which are left blank to evaluate fluorescent background due to buffers. The wells were covered with lids and the microtiter plates were incubated at 30° C. overnight.

The Pseudomonas fluorescens cultures were decanted off the next day, rinsed with 200 μl sterile cooling water (pH 7.3) three times. 200 μl of 20 ppm biodispersant chemical solution prepared in sterile cooling water (pH 7.3) was dispensed to each well. The microtiter plates were covered and allowed to incubate for 24 hours. The plates were then rinsed of biodispersant solution with 200 μl sterile saline buffer three times. At this point, the staining and quantification began. 10 μl 20× CyQUANT lysis buffer (Molecular Probe C7027) was dispensed to each well on the microplate. 190 μl saline buffer was added to each well. The plate was sealed with microplate tape, and incubated in a 65° C. water bath for 5 minutes. The plate was then centrifuged briefly (500 rpm for 1 minute) to collect the liquid to the bottom of each well. 90 μl of cell lysate was transferred to a new microplate containing 10 μl 10×Sybr Green 1 solution per well (Molecular Probe S-7585). The fluorescent intensity (RFU) of each stained cell lysate in the microplate reader was measured. (Excitation wavelength=485 nm and Emission wavelength=535 nm).

It was found that at 10 ppm working concentration treatment, Lupasol G20 and G35 have significant effect (P<0.05) on removal of PF 13525 biofilm on a costar clear microplate. Further details are set forth in the tables and graphs below.

### Microtiter Plate Test

### 50 ppm 20% Lupasol G20/G35 and 50 ppm EO/PO Biofilm Removal Efficiency

### Sbyr Green I Staining Results

| | | P.f. |
|---|---|---|
| Average | Chemical | 13525 |
| ½ | Blank | 104 |
| ¾ | Control | 8295 |
| ⅚ | EO/PO copolymer | 8766 |
| 7 | BD 1550 | 7926 |
| 9 | Lupasol G35 | 2251 |
| 10 | Lupasol G20 | 4013 |

| | | P.f. |
|---|---|---|
| Stdev | Chemical | 13525 |
| ½ | Blank | 16 |
| ¾ | Control | 1399 |
| ⅚ | EO/PO copolymer | 1918 |
| 7 | BD 1550 | 1780 |
| 9 | Lupasol G35 | 1401 |
| 10 | Lupasol G20 | 1197 |

| Biofilm | | P.f. |
|---|---|---|
| Removal | Chemical | 13525 |
| ½ | Blank | |
| ¾ | Control | |
| ⅚ | EO/PO copolymer | −6% |
| 7 | BD 1550 | 4% |
| 9 | Lupasol G35 | 73% |
| 10 | Lupasol G20 | 52% |

*Means that are statistically lower than control

While the present invention has been described with references to preferred embodiments, various changes or substitutions may be made on these embodiments by those ordinarily skilled in the art pertinent to the present invention with out departing from the technical scope of the present invention. Therefore, the technical scope of the present invention encompasses not only those embodiments described above, but all that fall within the scope of the appended claims.

What is claimed is:

1. A method for removing microbial biofilm on surfaces in contact with a system which comprises adding to the system an effective amount of a polyethyleneimine surfactant.

2. The method according to claim 1 wherein the system is an aqueous system.

3. The method according to claim 1 wherein the polyethyleneimine surfactant is present in the amount of from about 2 ppm to about 400 ppm.

4. The method according to claim 1 wherein the polyethyleneimine surfactant is present in the amount of from about 20 ppm to about 120 ppm.

5. The method according to claim 1 wherein the polyethyleneimine surfactant is present in the amount of from about 40 ppm to about 60 ppm.

6. The method according to claim 1 wherein the aqueous system has a pH of from about 3.5 to about 10.5.

7. The method according to claim 1 wherein the polyethyleneimine surfactant is about 50% active.

8. The method according to claim 1 wherein the surfactant comprises from about 20 to about 98% by weight polyethyleneimine.

9. The method according to claim 1 wherein the surfactant comprises from about 40 to about 60% by weight polyethyleneimine.

10. The method according to claim 1 wherein the system is chosen from the group consisting of open recirculating cooling water systems, pulping and papermaking systems, water transport pipelines, closed cooling systems, reverse osmosis systems, air washer systems, shower water systems, hydrocarbon storage systems, once-through water systems, hydrocarbon transporting pipelines, metalworking fluid systems, and aqueous mineral processing systems.
